(19) United States
(12) Patent Application Publication
(10) Pub. No.: US 2021/0294768 A1
(43) Pub. Date: Sep. 23, 2021

(54) FIELD DEVICE

(71) Applicant: ABB Schweiz AG, Baden (CH)

(72) Inventor: Georg HORST, Northeim (DE)

(21) Appl. No.: 17/197,213

(22) Filed: Mar. 10, 2021

(30) Foreign Application Priority Data
Mar. 23, 2020 (EP) 20 164 922.5

(51) Int. Cl. G06F 13/40; H04L 12/10

(52) U.S. Cl. CPC G06F 13/4022; H04L 12/10

(57) ABSTRACT

A field device includes: one or more digital and/or analogue interfaces; and an Ethernet interface. Power for the one or more digital and/or analogue interfaces is power derived from power for the Ethernet interface. In an embodiment, power for the field device is derived from the power for the Ethernet interface.

### CROSS-REFERENCE TO PRIOR APPLICATION

Priority is claimed to European Patent Application No. EP 20 164 922.5, filed on Mar. 23, 2020, the entire disclosure of which is hereby incorporated by reference herein.

### FIELD

The present invention relates to a field device as used in industrial measuring, such as a 4-wire filed device.

### BACKGROUND

Customer communication with field devices takes place via several digital and analogue interfaces, such as for 4-20 mA, pulse, frequency or switching output.

However, the overall field device, including its digital and analogue interfaces, becomes very complex in terms of power supply requirements.

There is a need to address this issue.

### SUMMARY

In an embodiment, the present invention provides a field device, comprising: one or more digital and/or analogue interfaces; and an Ethernet interface, wherein the field device is configured such that power for the one or more digital and/or analogue interfaces comprises power derived from power for the Ethernet interface.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of an example of a known field device; and

FIG. 2 shows a schematic representation of an example of a new field device.

### DETAILED DESCRIPTION

In an embodiment, the present invention provides an improved power supply technology for a field device.

In a first aspect, there is provided a field device, comprising:

one or more digital and/or analogue interfaces; and

an Ethernet interface;

The field device is configured such that power for the one or more digital and/or analogue interfaces is power derived from power for the Ethernet interface.

In this manner rather than having separate power supplies for each digital or analogue interface of a field device as required at present, a flexible power supply concept is provided where these interfaces obtain their voltage and power from the power supply for an Ethernet interface.

In an example, the field device is configured such that power for the field device is derived from the power for the Ethernet interface.

Thus, the field device itself does not require a separate power supply, but is taking its power from the power for the Ethernet interface.

In an example, the Ethernet interface comprises one or more Power over Ethernet (POE) capable switches and power for the one or more digital and/or analog interfaces is provided from the one or more POE capable switches.

In this manner, a simple and convenient power connection means is provided via POE capable switches for the Ethernet interface, enabling simple and easier retrofitting or replacement of analogue and digital interfaces to the field device.

In an example, one or more power lines for the one or more digital and/or analogue interfaces are configured to connect to the one or more POE capable switches.

In an example, power for the field device is provided from a POE capable switch.

In an example, a power line for the field device is configured to connect to the POE capable switch.

In an example, the power for the Ethernet interface is provided via an Ethernet cable.

Thus only one cable connection is required, that provides for both data communication and for all power needs.

In an example, the field device is a 4-wire field device.

In an example, the one or more digital and/or analogue interfaces are configured to be disconnected from the field device.

The above aspect and examples will become apparent from and be elucidated with reference to the embodiments described hereinafter.

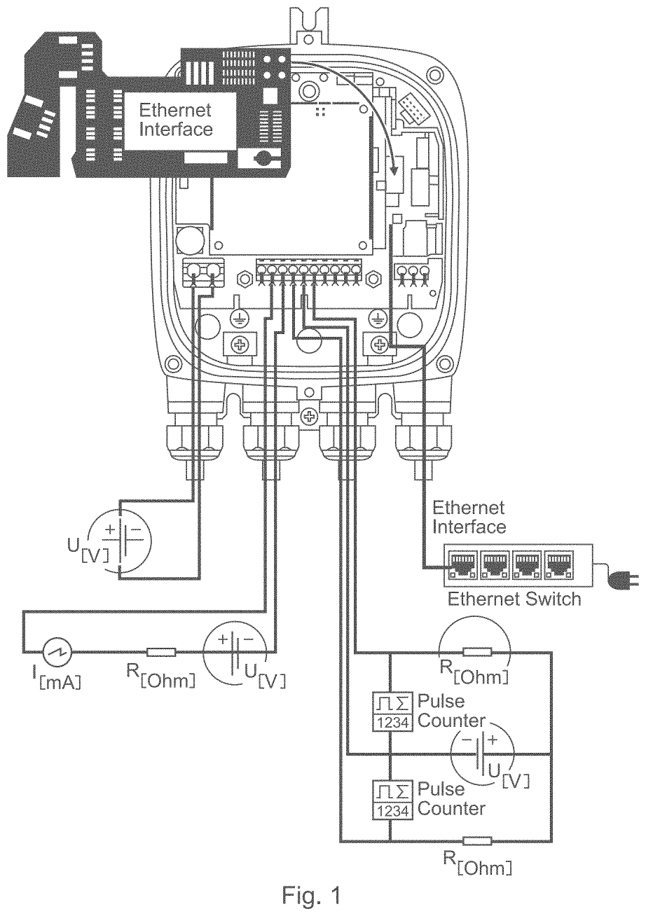

FIG. 1 shows a typical 4-wire field device, as usual in the field of industrial measuring technology. This has a separate voltage input source in order to the power up the device. Customer communication takes place via several digital and analogue interfaces. For contacting the analogue interfaces, such as 4-20 mA, pulse, frequency or switching output, the customer must then provide an additional, separate voltage source for supplying the interfaces with power.

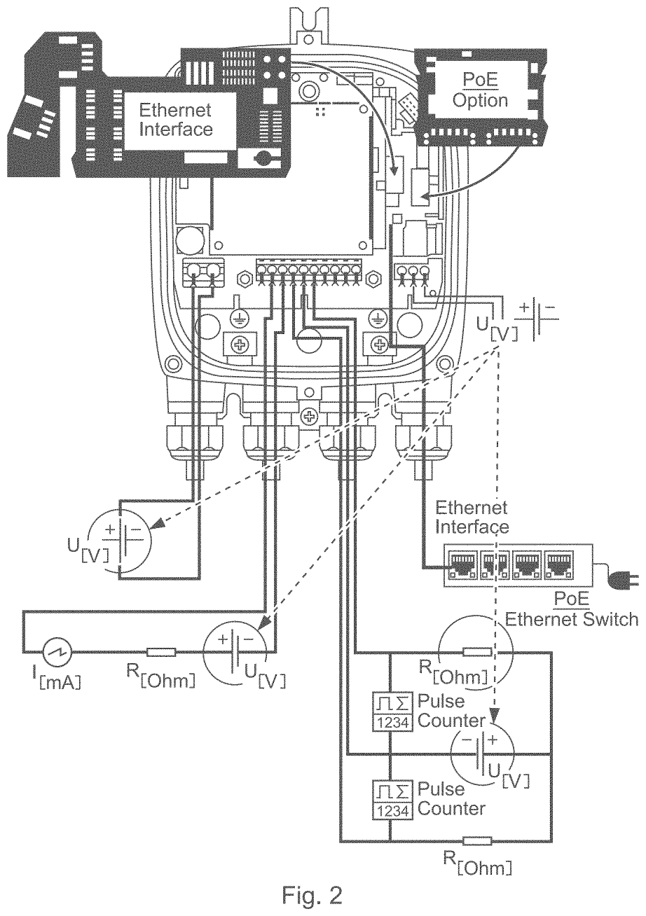

FIG. 2 shows a new field device, which reduces the cost of the field device and analogue and digital interfaces and reduces installation costs.

In an example, the new field device comprises one or more digital and/or analogue interfaces, and an Ethernet interface. The field device is configured such that power for the one or more digital and/or analogue interfaces is power derived from power for the Ethernet interface.

In an example, the field device is configured such that power for the field device is derived from the power for the Ethernet interface.

In an example, the Ethernet interface comprises one or more Power over Ethernet (POE) capable switches and power for the one or more digital and/or analog interfaces is provided from the one or more POE capable switches.

In an example, one or more power lines for the one or more digital and/or analogue interfaces are configured to connect to the one or more POE capable switches.

In an example, power for the field device is provided from a POE capable switch.

In an example, a power line for the field device is configured to connect to the POE capable switch.

In an example, the power for the Ethernet interface is provided via an Ethernet cable.

In an example, the field device is a 4-wire field device.

In an example, the one or more digital and/or analogue interfaces are configured to be disconnected from the field device.

Continuing with FIG. 2, a specific and detailed embodiment of the new field device is described.

The new field device also has an Ethernet interface. This can be used for configuration and maintenance as well as for the cyclic data exchange between terminal and control system. This Ethernet interface works in parallel with the analogue and digital 4-20 mA, Pulse, Frequency and Switch output signals. However, the Ethernet interface is also utilized as a means to provide power to the digital and analogue interfaces as well as power for the field device itself. This is shown via the arrows that extend from a number of Power over Ethernet (POE) capable switches of the Ethernet interface that extend to power supplies of a number of digital or analogue interfaces of the field device and a power supply of the field device itself. This represents that the POE capable switches can be used to replace these power supplies.

In this manner use of Power over Ethernet (POE) is made not just for the intended use of the device supply and Ethernet communication, but also for the supply of the device and its other analogue and digital interfaces. This leads to a device that is easier and cheaper to setup and easier and cheaper to install with respect to the setup and installation costs of a conventional field device. Also retrofit to the new field device with power based on POE powering is much easier and cost-effective than the installation of additional external voltage sources and electrical wires as required for a conventional field device.

With the POE technology (with Power over Ethernet, as defined in the IEEE802.3af) data and power can be made available via the same Ethernet cable, and separate power supplies are no longer needed. The voltage and power supply of the terminals or analogue and digital interfaces is provided by so-called POE capable switches. Thus the device communicates with a network via the same line via which it and its digital and analogue interfaces are being powered.

Continuing with FIG. 2, all external power sources, that are used only for the operation of the device itself as well as its digital and analogue interfaces, can be omitted. Furthermore, it is to be noted that it is not necessary that the POE general intended use cases of digital Ethernet communication with the remote station apply. Only the power transfer from the POE switch to the device and the digital and analogue interfaces is relevant here. With such a setup/installation, the customer saves all external power sources and the laying of additional electric wire to the device. The communication to the analogue and digital signals, such as 4-20 mA, pulse-, frequency- or switching output, is still the customer's primary relevant use case for the integration of the devices to a control system or to an evaluation unit. The Ethernet communication can be used for configuration and maintenance as well as for the cyclic data exchange between terminal and control system, but this does not have to be the case. The customer advantage here also results from the perspective that an already existing network structure can be reused, because retrofitting to a POE-capable switch can be realized in a more simply and cost-effectively way, than the installation of additional external voltage sources and electrical wires for the integration of the analogue and digital interfaces of the field devices.

The technology finds utility in field devices such as: Actuators; Positioners; Recorders & Controllers; Ultrasonic Level Transmitters & Switches; Coriolis Flowmeters; Compact dP Flowmeters; Electromagnetic Flowmeters; Thermal Mass Flowmeters; Variable Area Flowmeters; Swirl Flowmeters; Laser Level Transmitters & Scanners; Multivariable Transmitters; Vortex Flowmeters; Temperature Transmitters; Pressure Transducers; Pressure Transmitters, amongst others.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A field device, comprising:
one or more digital and/or analogue interfaces; and
an Ethernet interface,
wherein the field device is configured such that power for the one or more digital and/or analogue interfaces comprises power derived from power for the Ethernet interface.

2. The field device according to claim 1, wherein the field device is configured such that power for the field device is derived from the power for the Ethernet interface.

3. The field device according to claim 2, wherein the Ethernet interface comprises one or more Power over Ethernet (POE) capable switches, and
wherein power for the one or more digital and/or analog interfaces is provided from the one or more POE capable switches.

4. The field device according to claim 3, wherein one or more power lines for the one or more digital and/or analogue interfaces are configured to connect to the one or more POE capable switches.

5. The field device according to claim 3, wherein power for the field device is provided from a POE capable switch.

6. The field device according to claim 5, wherein a power line for the field device is configured to connect to the POE capable switch.

7. The field device according to claim 1, wherein the power for the Ethernet interface is provided via an Ethernet cable.

8. The field device according to claim 1, wherein the field device comprises a 4-wire field device.

9. The field device according to claim 1, wherein the one or more digital and/or analogue interfaces are configured to be disconnected from the field device.
